(19) United States
(12) Patent Application Publication
(10) Pub. No.: US 2017/0033470 A1
(43) Pub. Date: Feb. 2, 2017

(54) ANTENNA ARRANGEMENT

(71) Applicant: TELEFONAKTIEBOLAGET LM ERICSSON (PUBL), Stockholm (SE)

(72) Inventors: Sven PETERSSON, Sävedalen (SE); Fredrik ATHLEY, Kullavik (SE); Bo HAGERMAN, Tyresö (SE)

(73) Assignee: TELEFONAKTIEBOLAGET LM ERICSSON (PUBL), Stockholm (SE)

(21) Appl. No.: 15/302,268

(22) PCT Filed: Apr. 10, 2014
(86) PCT No.: PCT/EP2014/057263

§ 371 Date: Oct. 6, 2016

(51) Int. Cl. H01Q 21/24; H01Q 21/08; H01Q 1/24

(52) U.S. Cl. CPC H01Q 21/24; H01Q 1/246; H01Q 21/08

(57) ABSTRACT

There is presented an antenna arrangement with P polarization directions. The antenna arrangement comprises M transmission (Tx) ports and N reception (Rx) ports, where WN. The antenna arrangement comprises an antenna panel divided into S subpanels, where S=max (M, N)/P. The subpanels are, for each polarization direction, operatively connected to separate radio chains for the N Rx ports if N>M or for the M Tx ports if M>N.

### TECHNICAL FIELD

Embodiments presented herein relate to antenna arrangements, and particularly to antenna arrangements with P polarization directions and with unequal number of transmission ports and receiver ports.

### BACKGROUND

In communications networks, it may be challenging to obtain good performance and capacity for a given communications protocol, its parameters and the physical environment in which the communications network is deployed.

One component of wireless communications networks where it may be challenging to obtain good performance and capacity is the antennas of network nodes configured for wireless communications; either to/from another network node, and/or to/from a wireless user terminal. For example, a significant portion of network nodes deployed today are equipped with two reception (Rx) branches; in many cases by means of dual polarized antennas.

Demands for improved uplink performance sometimes require the number of Rx branches to be increased to four (or more), which often means that an extra antenna is mounted at the network nodes. Alternatively the existing antenna may be replaced with, for example, a quad (dual column, dual polarized) antenna.

Both these options result in an increased total antenna area. The increased total antenna area given by either mounting an additional antenna or replacing the existing antenna with a new antenna is in some cases not acceptable, especially at lower frequencies where antenna areas are quite large.

Hence, there is a need for an improved antenna arrangement.

### SUMMARY

An object of embodiments herein is to provide an improved antenna arrangement.

According to a first aspect there is presented an antenna arrangement with P polarization directions. The antenna arrangement comprises M transmission (Tx) ports and N reception (Rx) ports, where M#N. The antenna arrangement comprises an antenna panel divided into S subpanels, where S=max (M, N)/P. The subpanels are, for each polarization direction, operatively connected to separate radio chains for the N Rx ports if N>M or for the M Tx ports if M>N.

Advantageously this provides an improved antenna arrangement.

Advantageously this provides an antenna arrangement with equal or better performance than existing antenna arrangements.

Advantageously, this, for example, enables an antenna arrangement with 2 Tx ports and 4 Rx ports within the same area as a conventional antenna arrangement with 2 Tx ports and 2 Rx ports.

According to a second aspect there is presented a network node comprising an antenna arrangement according to the first aspect.

According to a third aspect there is presented a wireless terminal comprising an antenna arrangement according to the first aspect.

It is to be noted that any feature of the first, second, and third aspects may be applied to any other aspect, wherever appropriate. Likewise, any advantage of the first aspect may equally apply to the second, and/or third aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1 to 7 are schematic diagrams illustrating antenna arrangements according to embodiments;

FIGS. 8 to 14 show simulation results according to embodiments;

FIG. 15 schematically illustrates a network node comprising an antenna arrangement according to embodiments; and

FIG. 16 schematically illustrates a wireless terminal comprising an antenna arrangement according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

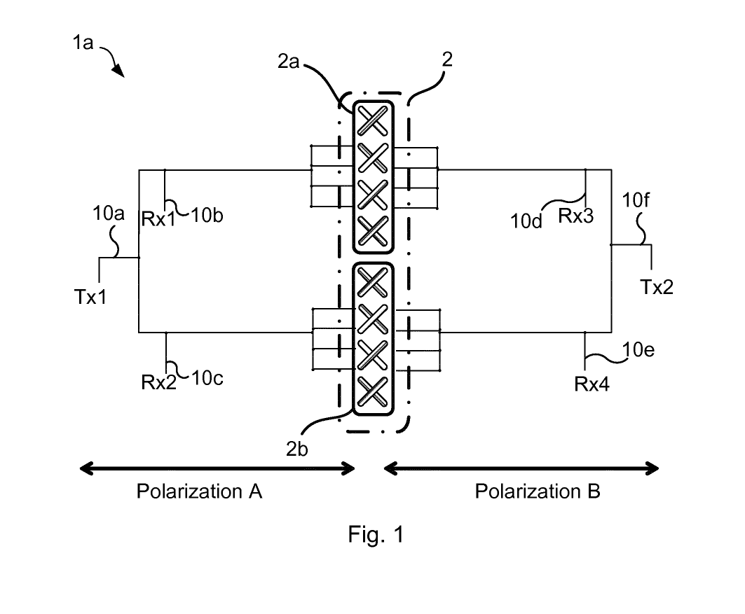

The embodiments disclosed herein relate to antenna arrangements with P polarization directions and with unequal number of transmission ports and receiver ports. General references are now made to FIGS. 1-7 illustrating antenna arrangements 1a, 1b, 1c, 1d, 1e, 1f, 1g with P polarization directions, where P=1 or where P=2.

Particular reference is made to FIG. 1 illustrating an antenna arrangement 1a according to an embodiment. The antenna arrangement 1a of FIG. 1 has 2 polarization directions. In general terms, the herein disclosed antenna arrangements have P polarization directions where P=1 or P=2.

The antenna arrangement 1a comprises two transmission (Tx) ports, Tx1, and Tx2. In general terms, the herein disclosed antenna arrangements have M transmission ports. The antenna arrangement 1a comprises four reception (Rx) ports, Rx1, Rx2, Rx3, and Rx4. In general terms, the herein disclosed antenna arrangements have N reception ports, where M#N. That is, the number of Tx ports is different from the number of Rx ports.

The antenna arrangement 1a comprises an antenna panel 2. The herein disclosed embodiments are based on splitting the antenna panel 2 into at least two subpanels. The antenna panel 2 of the antenna arrangement 1a is divided into two subpanels 2a, 2b. In general terms, the herein disclosed antenna arrangements have S subpanels, where S=max (M, N)/P. That is, the number of subpanels S is equal to the maximum of the number of Tx ports and the number of Rx ports divided by the number of polarization directions.

The subpanels 2a, 2b, are for each polarization direction operatively connected to separate radio chains 10a, 10b, 10c, 10d, 10e, 10f for the N Rx ports if N>M or for the M Tx ports if M>N. For the antenna arrangement 1a N=4 and M=2 and hence the subpanels 2a, 2b, are for each polarization direction operatively connected to separate radio chains 10b, 10c, 10d, 10e for the four Rx ports.

The disclosed antenna arrangement 1a may for example offer 2 Tx ports and 4 Rx ports within the same area as a conventional 2 Tx and 2 Rx antenna.

Further details of the herein disclosed antenna arrangements will now be disclosed with continued references to the antenna arrangements 1a, 1b, 1c, 1d, 1e, 1f, 1g of FIGS. 1-7.

In general terms, the herein disclosed antenna arrangement may according to some embodiments comprise two (or more) single or dual polarized subpanels 2a-d stacked on top of each other and/or placed beside each other. These subpanels are operatively connected to unequal number of Tx ports and Rx ports. For example, although the subpanels 2a-d of each of the herein disclosed antenna arrangements for simplicity are described as being identical, in the general case they may not be identical, for example containing a different number of antenna elements per subpanels.

There may be more Rx ports than Tx ports. That is according to an embodiment, N>M. This is the case for the antenna arrangements 1a, 1b, 1c, 1d, 1e (and depending on the actual configuration used, possible also for antenna arrangement 1g). There may be more Tx ports than Rx ports. That is according to an embodiment, M>N. This is the case for the antenna arrangement 1f (and depending on the actual configuration used, possible also for antenna arrangement 1g). The number of Tx ports and/or Rx ports may be based on the number of polarizations. Particularly, according to an embodiment, min (M, N) P. That is, the minimum of the number of Tx ports and the number of Rx ports may be larger than or equal to the number of polarization directions. Further, min (M, N) may be a multiple of P.

According to an embodiment the antenna panel 2 is a one-dimensional antenna array. FIGS. 1-5 illustrate such antenna arrangements 1a-1e.

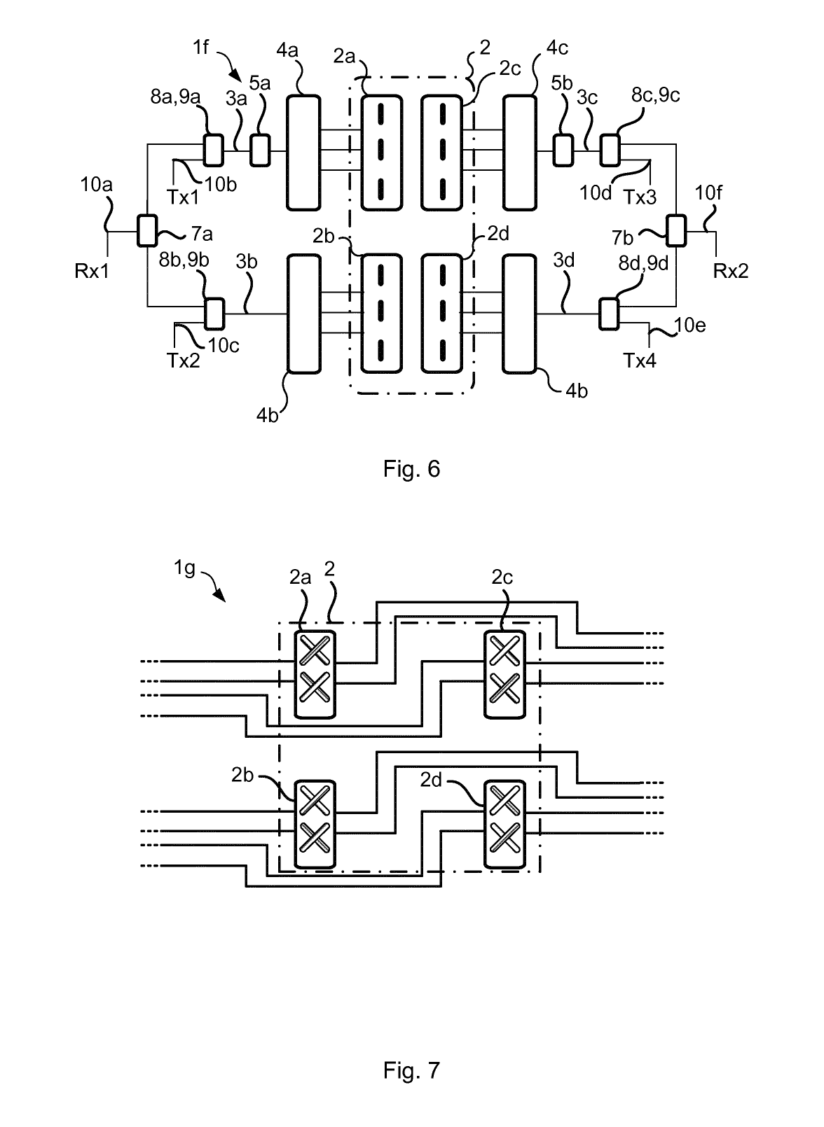

According to an embodiment the antenna panel 2 is a two-dimensional antenna array. FIGS. 6 and 7 illustrate such antenna arrangements 1f-1g.

According to an embodiment all subpanels 2a-d are identical. According to an alternative embodiment the antenna arrangement 1a, 1b, 1c, 1d, 1e, 1f, 1g comprises at least two different types of subpanels. Hence, all subpanels 2a-d may or may not have identical elements and/or components.

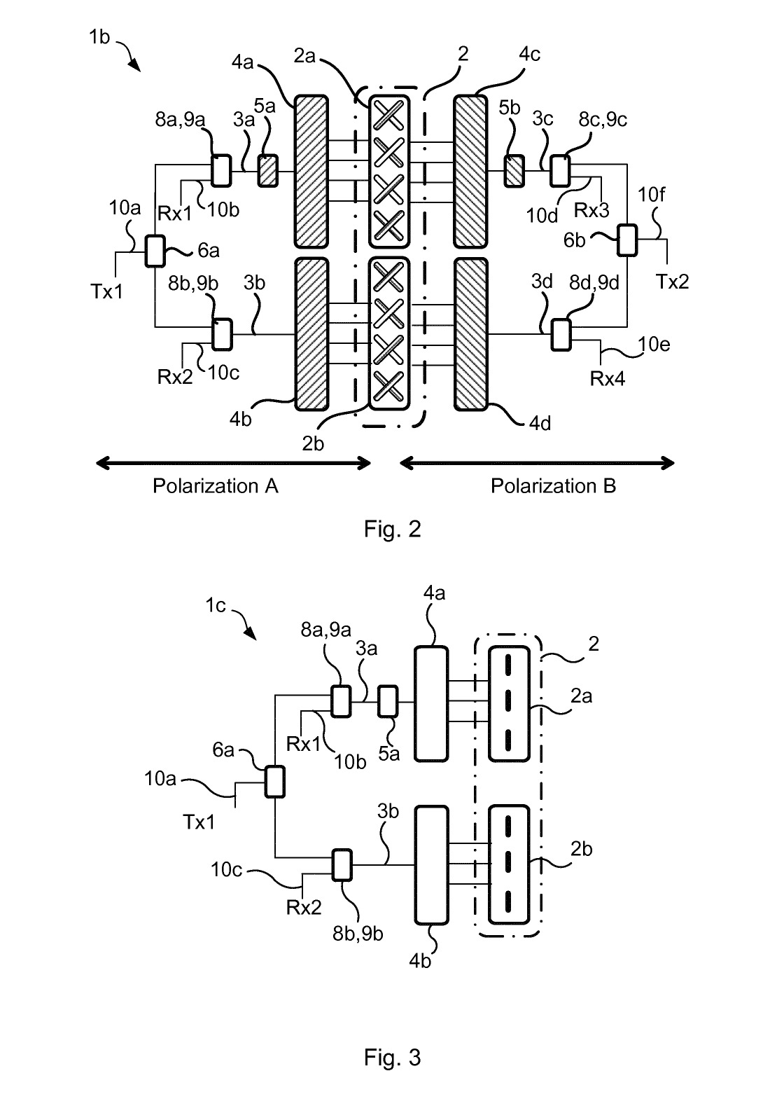

In general terms, any of the herein disclosed antenna arrangements may comprise additional functional blocks, such as any of distribution networks, phase shifters, splitter modules or combiner modules, and duplex modules or switch modules. Two or more of these functional blocks may be implemented in the same physical building block. Such further details of the herein disclosed antenna arrangements will now be disclosed with continued references to the antenna arrangements 1b, 1c, 1d, 1e, 1f, 1g of FIGS. 2-7.

According to some embodiments the antenna arrangement 1b, 1c, 1d, 1e, 1f, 1g further comprises separate distribution networks 4a, 4b, 4c, 4d, 4e, 4f, 4g, 4h for each subpanel 2a, 2b, 2c, 2d and for each polarization direction. The separate distribution networks 4a, 4b, 4c, 4d, 4e, 4f, 4g, 4h are operatively connected between the subpanels 2a, 2b, 2c, 2d and the radio chains 10a-h. The separate distribution networks 4a, 4b, 4c, 4d, 4e, 4f, 4g, 4h may be configured for at least one of amplitude tapering and variable phase shifting (electrical tilt). For example, the separate distribution networks 4a, 4b, 4c, 4d, 4e, 4f, 4g, 4h may be configured for a fixed amplitude and phase plus variable phase shifting. For example, the separate distribution networks 4a, 4b, 4c, 4d, 4e, 4f, 4g, 4h may be configured for fixed phase tapering.

The distribution networks 4a, 4b, 4c, 4d, 4e, 4f, 4g, 4h may have the same or different settings. Thus, according to some embodiments at least two of the distribution networks have different settings. For example, at least two of the distribution networks may have different tilt settings. Alternatively the separate distribution networks 4a, 4b, 4c, 4d, 4e, 4f, 4g, 4h may be configured for fixed tilt and/or for fixed phase tapering. The distribution network, per subpanel, may apply desired amplitude and phase taper to create desired properties such as beam shaping. For example, the phase taper may be variable to achieve desired variable beam properties such as null-fill. The joint distribution network 4a, 4b, 4c, 4d, 4e, 4f, 4g, 4h may, over all subpanels 2a, 2b, 2c, 2d, create a joint common beam shape/property for the joint set of antenna elements over all subpanels, which may be desired for Tx, whilst being different for each subpanel or set of subpanels for Rx.

According to some embodiments the antenna arrangement 1b, 1c, 1d, 1e, 1f, 1g further comprises separate phase shifters 5a, 5b, 5c, 5d, 5e, 5f. Particularly, all but one subpanel may, for each polarization direction, be operatively connected to a separate phase shifter 5a, 5b, 5c, 5d, 5e, 5f between the subpanels 2a, 2b, 2c, 2d and the radio chains 10a-h. The phase shifter 5a, 5b, 5c, 5d, 5e, 5f should be regarded as functional blocks and may as such be implemented in separate circuitry or joint with other components of the antenna arrangement 1b, 1c, 1d, 1e, 1f, 1g. For example, the phase shifters 5a, 5b, 5c, 5d, 5e, 5f may be integrated with the distribution networks 4a, 4b, 4c, 4d, 4e, 4f, 4g, 4h. If implemented separately the distribution networks 4a, 4b, 4c, 4d, 4e, 4f, 4g, 4h may be operatively connected between the subpanels 2a, 2b, 2c, 2d and the phase shifters 5a, 5b, 5c, 5d, 5e, 5f.

According to some embodiments the antenna arrangements disclosed herein further comprises at least one splitter module or at least one combiner module (per polarization). Particular details related thereto will now be disclosed.

The antenna arrangements disclosed herein may further comprise, if N>M, at least one splitter module 6a, 6b, 6c, 6d. That is, the antenna arrangements disclosed herein may further comprise at least one splitter module 6a, 6b, 6c, 6d if the number of Rx ports is larger than the number of Tx ports. The at least one splitter module 6a, 6b, 6c, 6d is configured to split a Tx signal of one Tx radio chain into at least two Tx signals, each one of which is provided to a separate one of the subpanels 2a, 2b, 2c, 2d. The splitter modules 6a, 6b, 6c, 6d may be configured for equal or non-equal power splitting. Particularly, the at least one splitter module may be configured for non-equal power splitting of the one Tx radio chain. For N>M the subpanels (all or a subset larger than 1) may thus on Tx be fed with the same signal via a splitter module 6a, 6b, 6c, 6d and tilt device whereas on Rx each subpanel is individually accessible. The antenna arrangements disclosed herein may alternatively further comprise, if M>N, at least one combiner module 7a, 7b. That is, the antenna arrangements disclosed herein may further comprise at least one combiner module 7a, 7b if the number of Tx ports is larger than the number of Rx ports.

The at least one combiner module 7a, 7b is configured to combine at least two Rx signals received from separate ones of the subpanels 2a, 2b, 2c, 2d into one Rx signal of a joint Rx radio chain. For M>N the receivers (all or a subset larger than 1) may thus on Rx receive a combined signal via a combiner module 7a, 7b and tilt device whereas on Tx each subpanel is individually accessible.

According to some embodiments the antenna arrangements disclosed herein further comprises at least one duplex module or at least one switch module. Particular details related thereto will now be disclosed.

The antenna arrangements disclosed herein may further comprise at least one duplex module 8a, 8b, . . . , 8h. The at least one duplex module 8a, 8b, . . . , 8h is configured to perform frequency domain separation of one Tx signal received from one of the Tx radio chains and one Rx signal received from one of the subpanels 4a-h. Such arrangements may thus be suitable for frequency-division duplexing (FDD) of the Tx signals and the Rx signals. The antenna arrangements disclosed herein may alternatively further comprise at least one switch module 9a, 9b, . . . , 9h. The at least one switch module 9a, 9b, . . . , 9h is configured to perform time domain separation of one Tx signal received from one of the Tx radio chains and one Rx signal received from one of the subpanels. Such arrangements may thus be suitable for time-division duplexing (TDD) of the Tx signals and the Rx signals.

Particular reference is now made to FIG. 2 illustrating an antenna arrangement 1b with P=2 polarization directions, where N=4, where M=2, and where S=2. In more detail the antenna arrangement 1b comprises two dual polarized antenna subpanels 2a, 2b mounted vertically on top of each other. Each polarization in each subpanel 2a, 2b is operatively connected to a distribution network 4a, 4b, 4c, 4d configured for amplitude tapering and variable phase shifting in order to give the desired tilt and beam shape for the subpanel it is operatively connected to. In many applications the tilt setting will be the same for both subpanels 2a, 2b but there is no requirement for that and the subpanels 2a, 2b could thus be set individually. Different tilt settings may be used for affecting the beam shape. By means of phase shifters 5a, 5b in the upper branches of each polarization direction the phase for the two subpanels 2a, 2b is set to a desired value, typically to generate a total amplitude and phase distribution of the transmit signal over the entire antenna panel 2, for example to align the phase fronts from the two subpanels 2a, 2b according to a tilt setting. The phase shifters 5a, 5b may alternatively be placed in the lower branches of each polarization direction, or one in an upper branch and one in a lower branch, etc. In general terms, there is no need for separate phase shifters 5a, 5b; the functionality thereof may be included in the distribution networks 4a, 4c (and/or 4b, 4d). Two duplex modules 8a-d or switch modules 9a-d per polarization are used to separate the Rx signal from each subpanel and polarization direction into separate Rx signals Rx1, Rx2, Rx3, Rx4 (in order to enable desired isolation between the Tx signals and the Rx signals) as provided to the radio chains 10b, 10c, 10d, 10e. Finally, one splitter module 6a, 6b per polarization direction is used to generate two Tx signals (one per subpanel) from a single Tx input signal Tx1, Tx2 for each polarization direction as received on the radio chains 10a, 10f.

Particular reference is now made to FIG. 3 illustrating an antenna arrangement 1c with P=1 polarization direction, where N=2, where M=1, and where S=2. The antenna arrangement 1c of FIG. 3 thus differs from the antenna arrangement 1b of FIG. 2 in that the antenna arrangement 1c of FIG. 3 comprises two single polarized antenna subpanels 2a, 2b mounted vertically on top of each other. Each subpanel 2a, 2b is operatively connected to a distribution network 4a, 4b configured for amplitude tapering and variable phase shifting in order to give the desired tilt and beam shape for the subpanel it is operatively connected to. By means of a phase shifter 5a in one branch (according to the illustrative example of FIG. 3 the upper branch) the phase for the two subpanels 2a, 2b is set to a desired value, typically to generate a total amplitude and phase distribution of the transmit signal over the entire antenna panel 2, including tilt setting per subpanel 2a, 2b, for example to align the phase fronts from the two subpanels 2a, 2b according to a tilt setting. Two duplex modules 8a, 8b or switch modules 9a, 9b are used to separate the Rx signal from each subpanel 2a, 2b into separate Rx signals Rx1, Rx2 (in order to enable desired isolation between the Tx signals and the Rx signals) as provided to the radio chains 10b, 10c. Finally, one splitter module 6a is used to generate two Tx signals (one per subpanel) from a single Tx input signal Tx1 as received on the radio chain 10a.

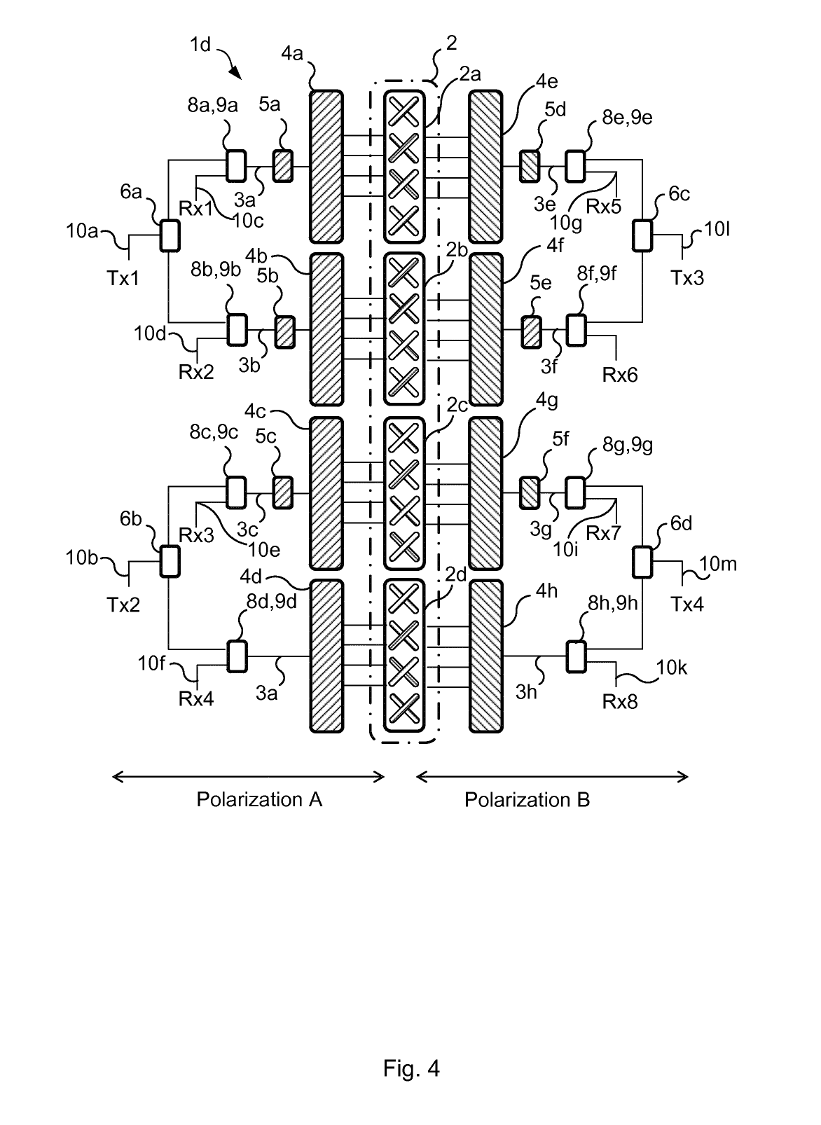

Particular reference is now made to FIG. 4 illustrating an antenna arrangement 1d with P=2 polarization directions, where N=8, where M=4, and where S=4. The antenna arrangement 1d of FIG. 4 thus differs from the antenna arrangement 1b of FIG. 2 in that the antenna arrangement 1d of FIG. 4 comprises four dual polarized antenna subpanels 2a, 2b, 2c, 2d mounted vertically on top of each other. Further, the antenna arrangement 1d of FIG. 4 additionally comprises separate phase shifters 5a, 5b, 5c, 5d, 5e, 5f for all but the bottom two subpanels 2d, 2h for each polarization direction. Each pair of subpanels, i.e., subpanels 2a and 2b, subpanels 2c and 2d, subpanels 2e and 2f, and subpanels 2g and 2h are operatively connected to a common Tx radio chain 10a, 10b, 10l, 10m, thus enabling four Tx signals Tx1, Tx2, Tx3, Tx4 to be transmitted.

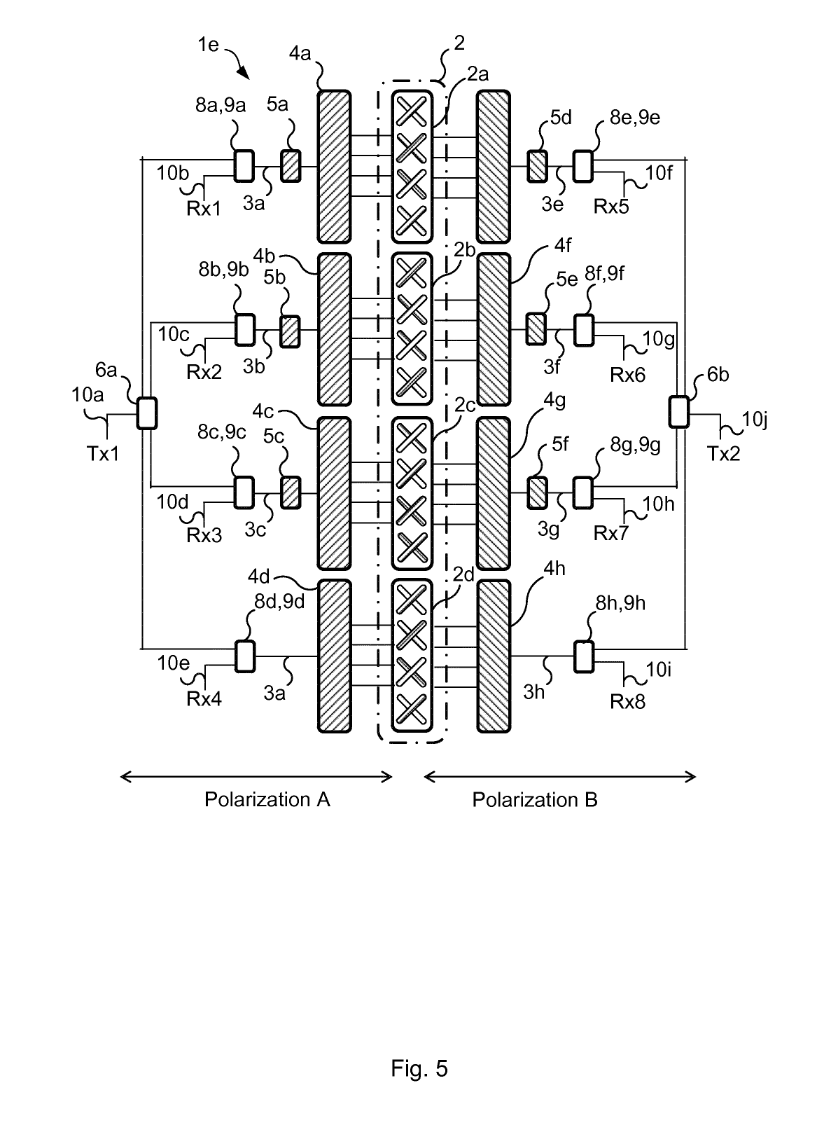

Particular reference is now made to FIG. 5 illustrating an antenna arrangement 1e with P=2 polarization directions, where N=8, where M=2, and where S=4. The antenna arrangement 1e of FIG. 5 thus differs from the antenna arrangement 1d of FIG. 4 in that according to the antenna arrangement 1e of FIG. 5 all subpanels, for each polarization direction, are operatively connected to one Tx radio chain 10a, 10bj, thus enabling two Tx signals Tx1, Tx2, to be transmitted.

Particular reference is now made to FIG. 6 illustrating an antenna arrangement 1f with P=1 polarization direction, where N=2, where M=4, and where S=4. The antenna arrangement 1f of FIG. 6 thus differs from the antenna arrangement 1c of FIG. 3 firstly in that the antenna arrangement 1f of FIG. 6 comprises a two-dimensional antenna panel 2 divided into four single polarized antenna subpanels 2a, 2b, 2c, 2d pairwise mounted vertically on top of each other. The antenna arrangement if of FIG. 6 further differs from the antenna arrangement 1c of FIG. 3 in that the antenna arrangement if of FIG. 6 comprises two combiner modules 7a, 7b instead of one splitter module 6a. The antenna arrangement if of FIG. 6 further differs from the antenna arrangement 1c of FIG. 3 in that the antenna arrangement if of FIG. 6 comprises more Tx ports (Tx1, Tx2, Tx3, Tx4 connected via radio chains 10b, 10c, 10d, and 10e, respectively) than Rx ports (Rxl, Rx2 connected via radio chains 10a, 10f). The antenna arrangement 1f of FIG. 6 thus enables reception of two Rx signals and transmission of four Tx signals.

Particular reference is now made to FIG. 7 illustrating an antenna arrangement 1g with P=2 polarization directions, and where S=4. According to the embodiment illustrated in FIG. 7, the antenna panel 2 is a two-dimensional antenna array and comprises subpanels 2a, 2b, 2c, 2d. Depending on the actual configuration desired, the antenna arrangement 1g may be used either as an antenna arrangement with N=8 and M=2 or M=4, or with M=8 and N=2 or N=4.

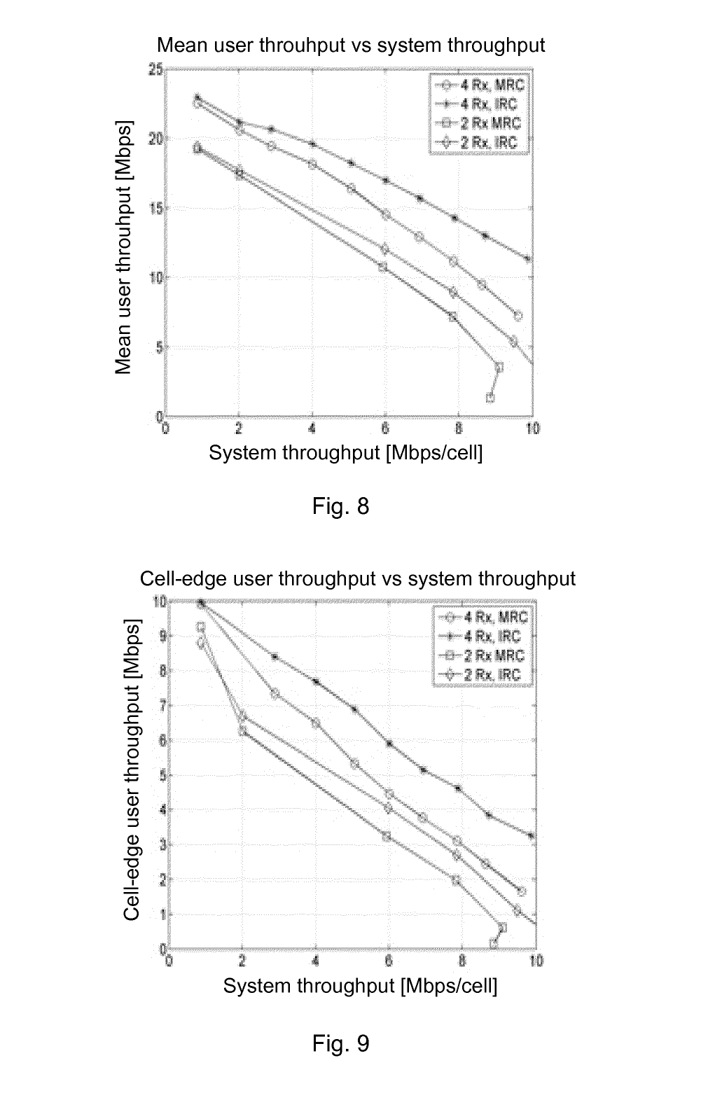

FIG. 8 provides simulation results of mean user throughput (in Mbps) as a function of system throughput (in Mbps per cell) in a 3GPP case 1 scenario (uplink). FIG. 9 provides simulation results of cell-edge (5%-ile) user throughput (in Mbps) as a function of system throughput (in Mbps per cell) in a 3GPP case 1 scenario (uplink). Further, results are provided for both maximum ratio combining (MRC) receivers and interference rejection combing (IRC) receivers, respectively. Table 1 summarizes some of the simulation parameters used.

TABLE 2
Simulation parameters used for results in FIGS. 8 and 9

| Simulation scenario | 3GPP case 1 | |
|---|---|---|
| System bandwidth | 10 | MHz |
| Channel model | 3GPP SCM urban macro | |
| Traffic model | Equal buffer file upload | |
| Number of antenna radiating | 8 | |
| elements (per polarization) | | |
| Antenna element separation | 0.7 | wavelengths |
| Antenna gain | 18 | dBi |

In more detail, FIGS. 8 and 9 show a performance comparison of the proposed antenna arrangement, in the plots referred to as “4 Rx”, and a conventional 2 Rx antenna, referred to as “2 Rx”, obtained from system simulations of a 3GPP case 1 scenario. The proposed antenna arrangement and the conventional antenna arrangement have the same antenna area.

The results in FIGS. 8 and 9 show that the proposed 4 Rx antenna arrangement offers substantial performance improvements over the conventional 2 Rx antenna.

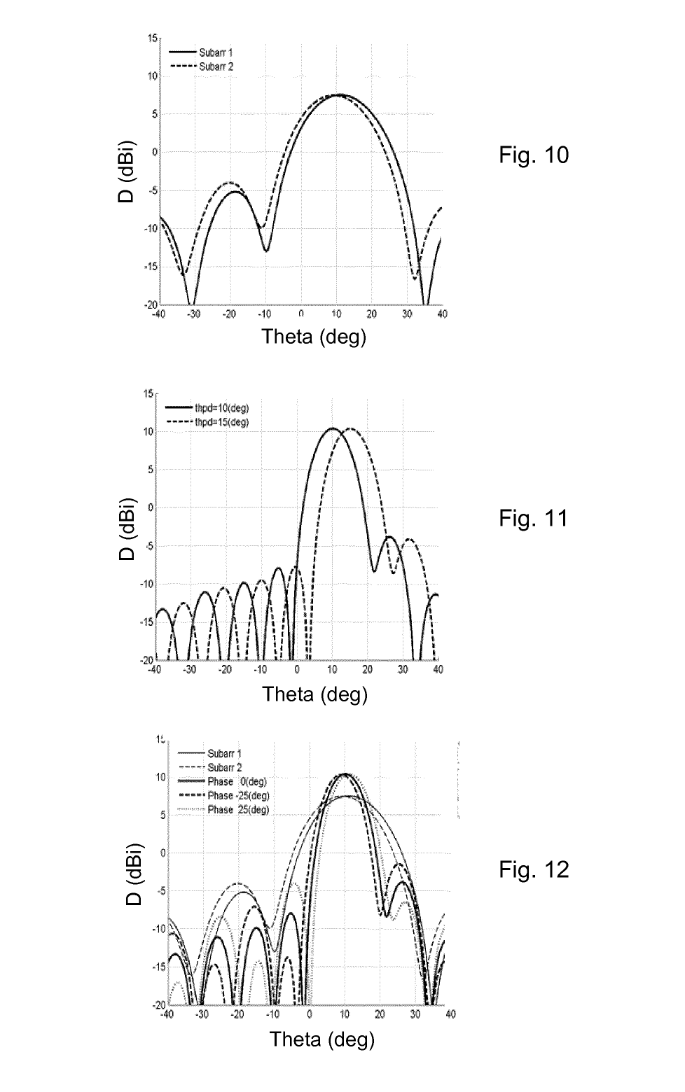

FIGS. 10, 11, 12, 13, and 14 show further beam pattern examples for the proposed antenna arrangements. In FIGS. 10 to 14 it is assumed that the proposed antenna arrangements are provided in a network node providing network coverage to a wireless terminal.

Table 2 summarizes some of the parameters valid for FIGS. 10 to 14.

TABLE 2
Simulation parameters used for results in FIGS. 10 to 14

| Element half-power | 90 | degrees |
|---|---|---|
| beamwidth | | |
| Number of antenna radiating | 8 | |
| elements (per polarization) | | |
| Antenna element separation | 0.7 | wavelengths |

In all plots except the dashed curve in FIG. 11 the phase taper for the subpanels, including tilt setting, is designed for a desired pointing direction of 10 degrees in downlink

FIG. 10 shows subpanel patterns. The patterns are not perfectly identical since a taper is applied over all elements in the antenna panel to give a desired downlink beam pattern

FIG. 11 shows downlink (DL) beam examples for different tilt settings.

FIG. 12 shows downlink beam examples for different settings of the external phase shifters. The phase shift for the subpanels is given for a pointing direction of 10 degrees. Changing this phase may only affect the downlink since the phase shift can be compensated for in uplink. FIG. 12 thus shows an example of how the downlink beam pattern can be changed, for example to affect the sidelobes, by adjusting the external phase shifters

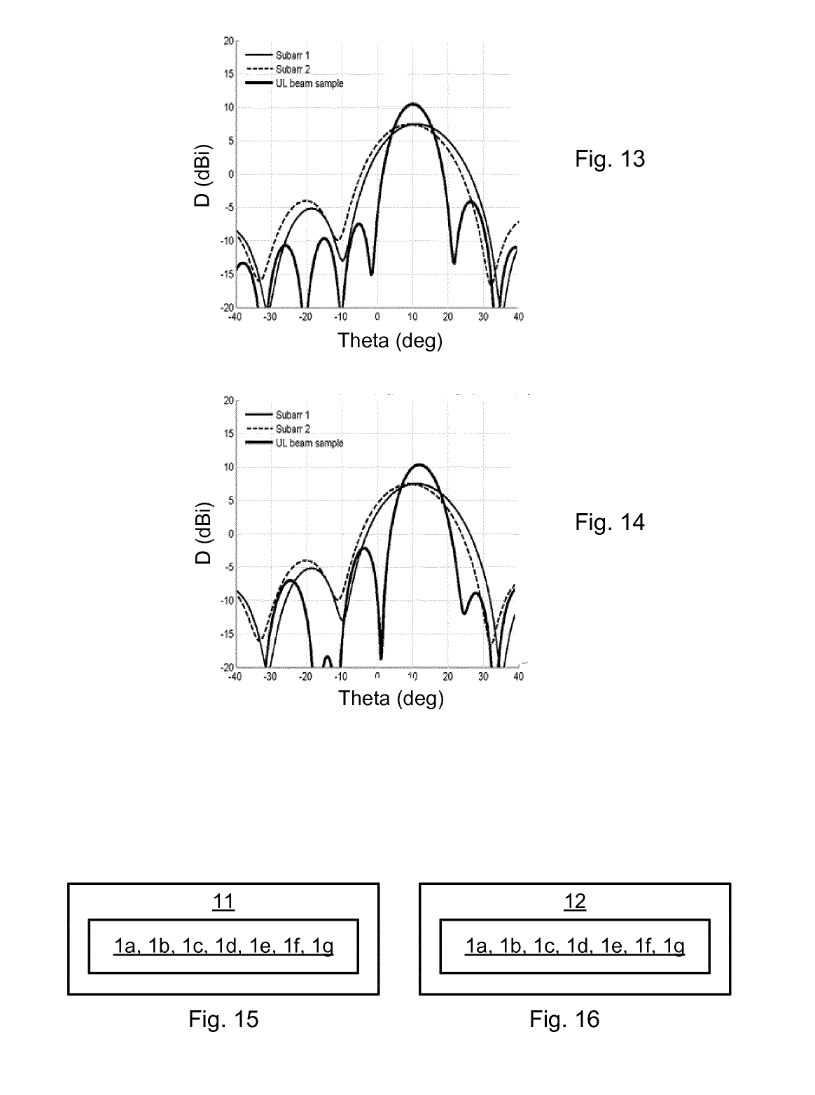

FIG. 13 shows the resulting uplink (UL) beam after MRC combination for a wireless terminal location of 10 degrees. The tilt setting for the subpanels is given by a desired beam pointing direction in the downlink of 10 degrees.

FIG. 14 shows an example of UL beams after MRC combination for a wireless terminal location of 12.5 degrees. The tilt setting for the subpanels is given by a desired beam pointing of 10 degrees.

The antenna arrangements 1a-g may be provided as standalone circuitry or as a part of a device. For example, any of the antenna arrangements 1a-g may be provided in a network node 11. FIG. 15 schematically illustrates a network node 11 comprising any one of the herein disclosed antenna arrangements 1a-g. The network node 11 may be a radio base station, such as a base transceiver station, a Node B, an Evolved Node B, a repeater, a relay, or the like. For example, any of the antenna arrangements 1a-g may be provided in a wireless terminal 12. FIG. 16 schematically illustrates a wireless terminal 12 comprising any one of the herein disclosed antenna arrangements 1a-g. The wireless terminal 12 may be a mobile phone, a user equipment, a smartphone, a tablet computer, a laptop computer, or the like. The antenna arrangement 1a-g may be provided as an integral part of the network node 11 or the wireless terminal 12. That is, the components of the antenna arrangement 1a-g may be integrated with other components of the network node 11 or wireless terminal 12; some components of the network node 11 or wireless terminal 12 and the antenna arrangement 1a-g may be shared.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. An antenna arrangement with P polarization directions, comprising:
M transmission, Tx, ports and N reception, Rx, ports, where M≠N; and
an antenna panel divided into S subpanels, where S=max (M, N)/P,
wherein the subpanels, for each polarization direction, are operatively connected to separate radio chains for the N Rx ports if N>M or for the M Tx ports if M>N.

2. The antenna arrangement according to claim 1, further comprising separate distribution networks for each subpanel and for each polarization direction, the separate distribution networks being operatively connected between the subpanels and the radio chains, and configured for at least one of amplitude tapering and variable phase shifting.

3. The antenna arrangement according to claim 2, wherein at least two of the distribution networks have different tilt settings.

4. The antenna arrangement according to claim 2 wherein at least two of the, distribution networks have different settings.

5. The antenna arrangement according to claim 1, wherein all but one subpanel, for each polarization direction, are operatively connected to a separate phase shifter between the subpanels and the radio chains.

6. The antenna arrangement according to claim 5, wherein the distribution networks are operatively connected between the subpanels and the phase shifters.

7. The antenna arrangement according to claim 5, wherein the phase shifters are integrated with the distribution networks.

8. The antenna arrangement according to claim 1, if N>M further comprising at least one splitter module configured to split a Tx signal of one Tx radio chain into at least two Tx signals, each one of which is provided to a separate one of the subpanels.

9. The antenna arrangement according to claim 8, wherein the at least one splitter module is configured for non-equal power splitting of the one Tx radio chain.

10. The antenna arrangement according to claim 1, if M>N further comprising at least one combiner module configured to combine at least two Rx signals received from separate ones of the subpanels into one Rx signal of a joint Rx radio chain.

11. The antenna arrangement according to claim 1, further comprising at least one duplex module configured to perform frequency domain separation of one Tx. signal received from one of the Tx radio chains and one Rx signal received from one of the subpanels.

12. The antenna arrangement according to claim 1, further comprising at least one switch module configured to perform time domain separation of one Tx signal received from one of the Tx radio chains and one Rx signal received from one of the subpanels.

13. The antenna arrangement according to claim 1, wherein all subpanels are identical.

14. The antenna arrangement according to claim 1, comprising at least two different types of subpanels.

15. The antenna arrangement according to claim 1, wherein N>M.

16. The antenna arrangement according to claim 1, wherein M>N.

17. The antenna arrangement according to claim 1 wherein min (M, N)≧P.

18. The antenna arrangement according to claim 1, wherein min (M, N) is a multiple of P.

19. The antenna arrangement according to claim 1, wherein the antenna panel is a one-dimensional antenna array.

20. The antenna arrangement according to claim 1, wherein the antenna panel is a two-dimensional antenna array.

21. A network node comprising an antenna arrangement according to claim 1.

22. A wireless terminal comprising an antenna arrangement according to claim 1.
